(19) United States
(12) Patent Application Publication
(10) Pub. No.: US 2010/0178842 A1
(43) Pub. Date: Jul. 15, 2010

(54) Hair Based Composite

(75) Inventor: Ronald Malcolm Thompson, London (GB)

Correspondence Address: MODERN TIMES LEGAL, ONE BROADWAY , 14TH FLOOR, CAMBRIDGE, MA, 02142, US

(73) Assignee: SOUTH BANK UNIVERSITY ENTERPRISES LIMITED, London (GB)

(21) Appl. No.: 12/304,777

(22) PCT Filed: Jun. 15, 2007
(86) PCT No.: PCT/GB2007/002248

§ 371 Date: Mar. 8, 2010

(30) Foreign Application Priority Data
Jun. 15, 2006 (GB) 0611884.8
May 23, 2007 (GB) 0709903.9

(51) Int. Cl. A63H 3/36; B32B 9/02; B29C 43/02

(52) U.S. Cl. 446/385; 156/178; 264/258

(57) ABSTRACT

A preferred embodiment of this invention relates to a method of manufacturing a hair-based composite material, the method comprising: manipulating a plurality of cut lengths of hair to form a web or mat of hair, and combining said web or mat of hair with a structural additive to form said composite material.

This invention relates to a hair-based composite material, and to a method of manufacturing such a material. Particularly preferred embodiments relate to a composite material that utilises human hair, and to a method of making such a composite. In a particularly preferred arrangement the composite is biodegradable or recyclable.

It has hitherto largely been the case that hair, for example human hair, has been viewed in most industries as a waste product. As such, hair salons and other such organisations which typically produce relatively large quantities of hair as they deal with their customers, have tended to throw away the hair with their usual daily rubbish, and in many cases that rubbish is then buried as landfill or transported elsewhere for disposal.

It is well known that hair has a relatively high tensile strength, and whilst it has previously been proposed to mix cut strands of animal hair as a binding material into plaster or concrete based products, it is the case that hair has otherwise largely been discounted for use as a structural material.

In contrast, it has been commonplace to use other fibre-based composite materials, such as glass reinforced plastic (known as GRP or fibreglass). Such materials have a mechanical strength which can exceed that of a hair based composite, but as they are not biodegradable they can only really be disposed of (in an economical fashion) by consigning them to landfill, and as such they are relatively environmentally unfriendly.

This problem is particularly prevalent in the clothing retail industry, as many thousands of mannequins (typically of fibreglass) are replaced every year. As there is no effective way to economically recycle old waste mannequins, they are typically consigned to landfill where they pose a significant environmental problem. Some of the more progressive retail companies have appreciated this problem and would like to purchase more environmentally friendly (or at least environmentally benign) mannequins, but commercially acceptable alternatives are not currently available.

Other composites in use today are made from petroleum-based products, and to reduce reliance upon finite petroleum resources it has been proposed to use composites such as MDF (a chipboard wood derivative). However, composites such as MDF may be carcinogenic, and as such it would be advantageous if an alternative composite material could be devised.

To this end, an aim of the present invention is to provide a novel composite material (and an accompanying method of manufacturing) which has acceptable mechanical properties (preferably comparable to that of similar fibre based products like GRP) but which is more environmentally friendly, either by utilising material which would otherwise be waste (for example hair) or in a particularly preferred arrangement by being fully biodegradable or recyclable.

By way of example, a presently preferred embodiment of the present invention provides a composite material consisting of a base material and a structural additive, the base material comprising hair configured and arranged as a web or mat (for example as a flexible, generally contiguous sheet of hair)—particularly but not exclusively human hair.

In preferred embodiments of the present invention, the structural additive may comprise one or more of: polymeric material, elastomeric material, a concrete-based material (particularly but not exclusively a resin concrete), a starch based material, a thermoplastic polymer material, a thermoset material, a polyamide, an epoxy-based resin, or a polyester resin. The base material may include a carrier, such as a web of fusible material (such as Bondaweb® or Wundaweb®), for carrying and supporting the hair.

The elastomeric material may comprise: a natural or synthetic rubber, it may be silicon-based, lactic (i.e. derived from milk products), cellulose or otherwise organic or oil based.

In a preferred arrangement the base material is formed of random cut lengths of hair configured and arranged as a web or mat. The hair base material may be formed from hair by a weaving process, a carding process, a felting process, a knitting process or a crochet process.

In general terms, presently preferred embodiments of the present invention may provide a sustainable composite material that is biocompatible, biodegradable or recyclable and includes an abundant biopolymer waste material. A method for forming a base material that comprises hair configured and arranged as a web or mat (for use in the manufacture of a composite as herein described) is also disclosed.

In one envisaged implementation, collected hair cuttings may be cleaned in acetone, carded, and then weaved on a spindle into a twine. The hair twine can then be weaved into webbing or matting which forms at least one component of the aforementioned base material for use in the manufacture of the composite.

In an alternative arrangement the base material may comprise loose strand felting manufactured from waste hair cuttings by any of a number of known methods, and this felting can then be used with a structural additive as hereinbefore described to form a composite. In particular, the base material may be combined with a liquid resin as the structural additive, so that on curing the resin acts to set the base material in a desired configuration and to reinforce the composite.

In a particularly preferred arrangement, the structural additive may comprise a biocompatible, eco-friendly and preferably recyclable bio-resin. Advantageously, a composite formed from such material would then be biodegradable, recyclable, sustainable, and eco-friendly.

As an alternative to including the aforementioned hair-based base material in a composite material, it will be apparent to persons of ordinary skill in the art that the base material may be put to a variety of different uses. For example, the base material could be used in the manufacture of blankets, clothing, armour, building fabric, organic compost, or compost blanket (such as a seed mat) for supporting the growth of micro-organisms.

The base material could also be used for the manufacture of medical devices, for example components such as replacement body parts (e.g. hip joints) or parts thereof, in conjunction with a structural additive that is suitable for use within the body. There may also be applications where the base material itself, without an applied structural additive, would be of utility.

In a particularly preferred arrangement the composite may comprise a polymeric or starch based resin as the structural additive for a human hair-based web or mat of random lengths of human hair held in a mat or web like configuration by a resin-dissolvable binder material.

In another arrangement, the composite may be formed by rolling out a collection of random lengths of hair, typically onto a board, to ensure even material density and constant flatness/thickness. Then a suitable binder may be applied to the hair to bind individual hairs together and thereby form a flexible, generally contiguous mat of hair. The mat may then be cut or stippled to the shape of a product to be moulded and a chosen structural additive such as a resin, for example, may be applied to the base material by any of a number of previously proposed processes, for example one of those used in the manufacture of glass reinforced plastic.

Presently preferred embodiments of the invention will be described in detail hereafter, by way of illustrative example only, with reference to the accompanying drawings, in which:

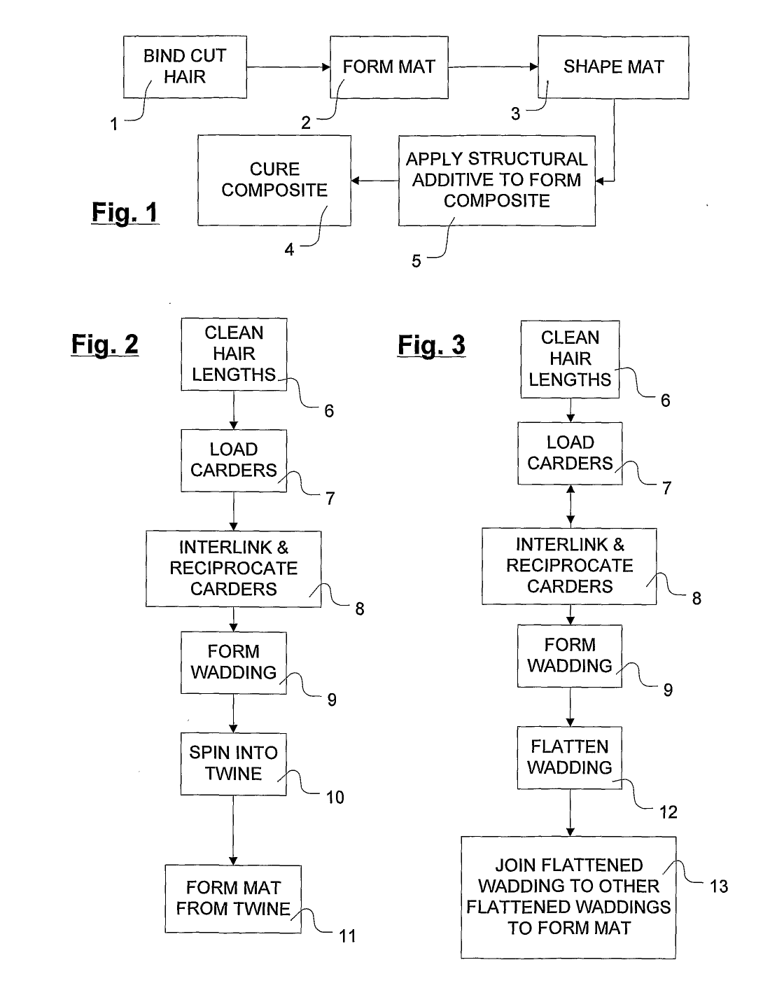

FIG. 1 is a flow diagram depicting the steps of an illustrate hair-based composite manufacturing method;

FIG. 2 is a flow diagram illustrating in more detail one way of accomplishing some of the steps of the process depicted in FIG. 1;

FIG. 3 is a flow diagram illustrating in more detail another way of accomplishing some of the steps of the process depicted in FIG. 1;

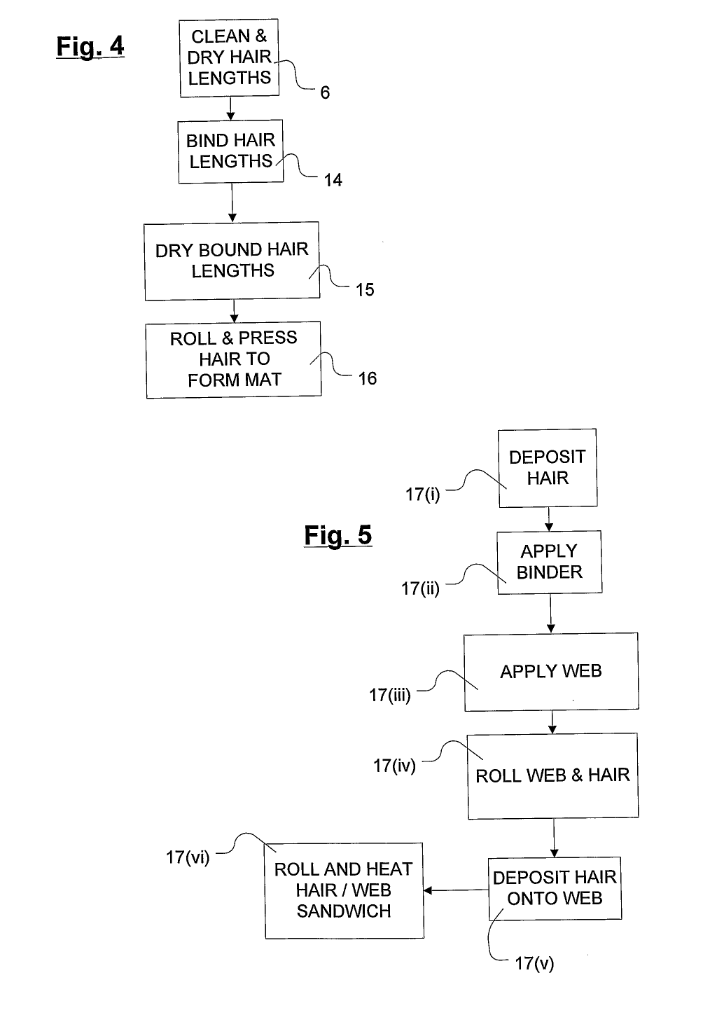

FIG. 4 is a flow diagram illustrating in more detail another way of accomplishing some of the steps of the process depicted in FIG. 1;

FIG. 5 is a flow diagram illustrating in more detail yet another way of accomplishing some of the steps of the process depicted in FIG. 1;

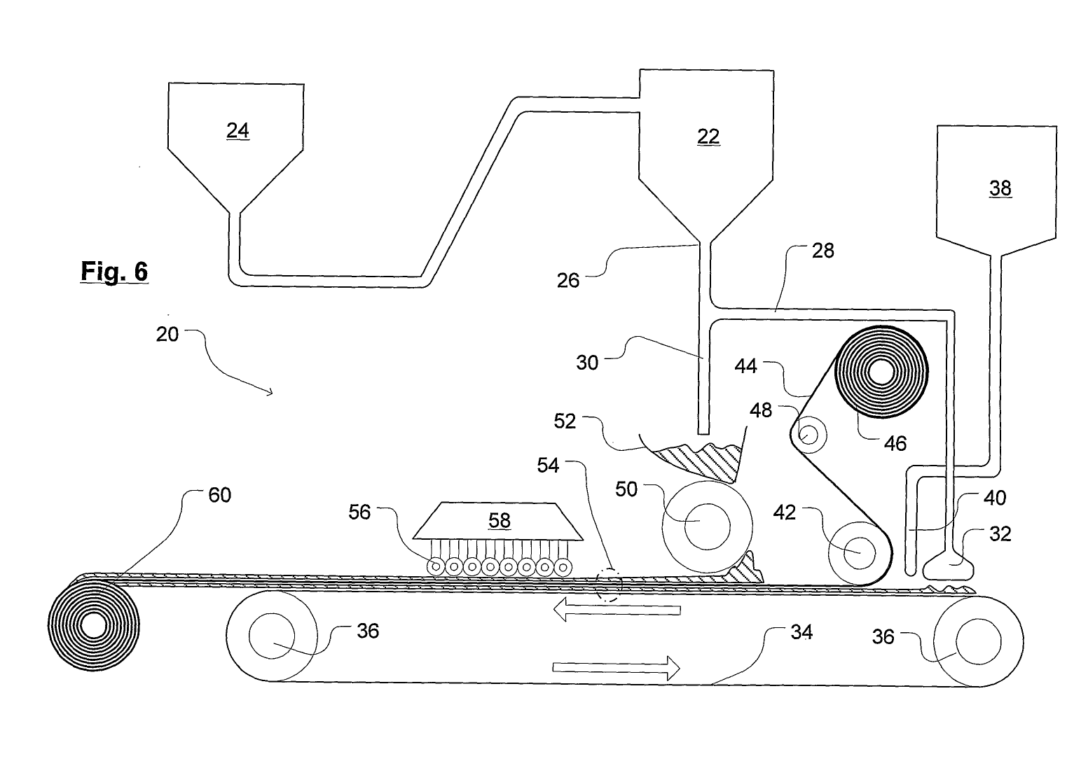

FIG. 6 is a schematic representation of illustrative machinery for producing a mat of hair consisting of outer hair layers bound to either side of a fusible web;

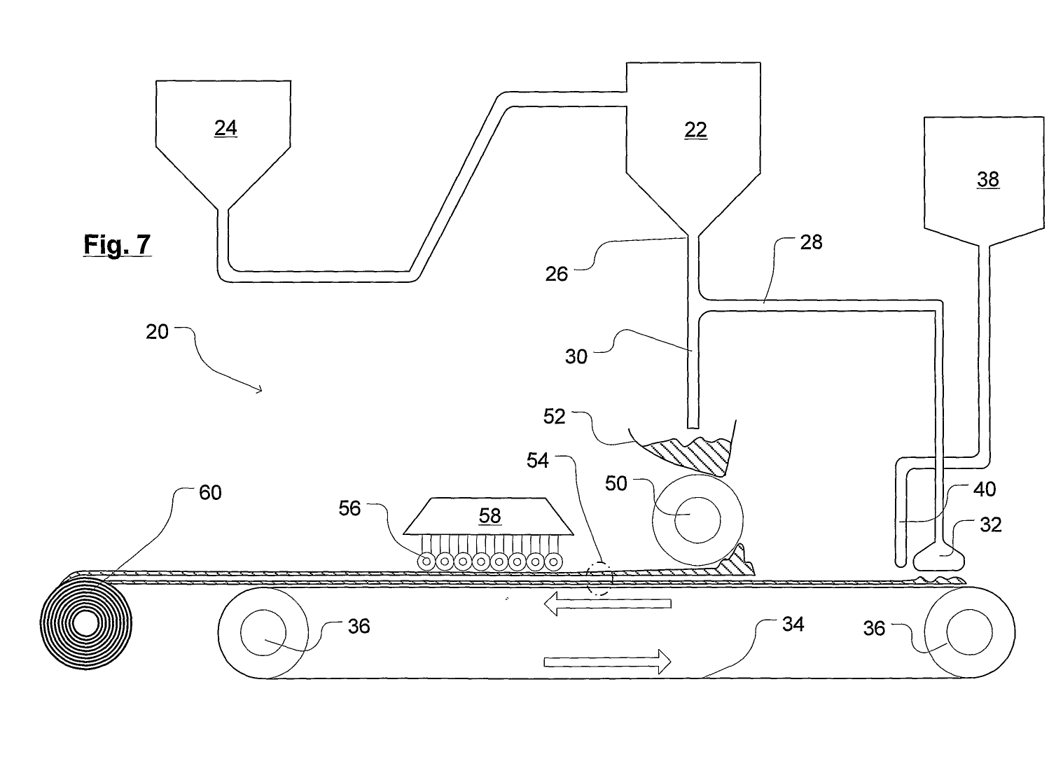

FIG. 7 is a schematic representation of illustrative machinery for producing a mat consisting of two bound layers of hair;

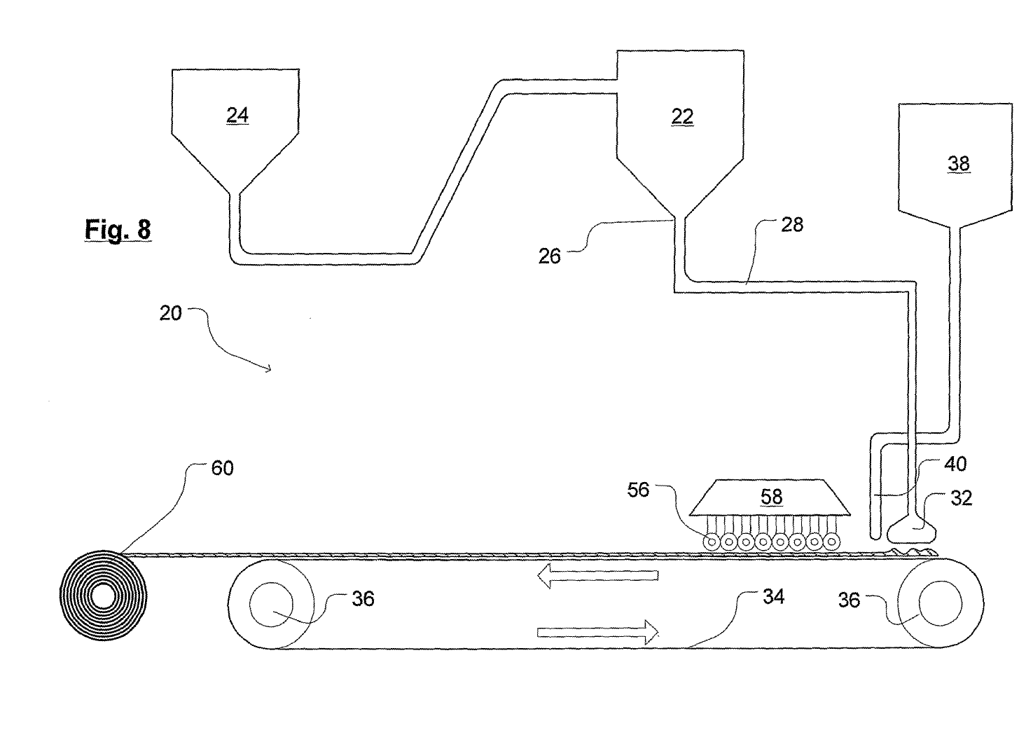

FIG. 8 is a schematic representation of illustrative machinery for producing a mat consisting of a single layer of hair; and

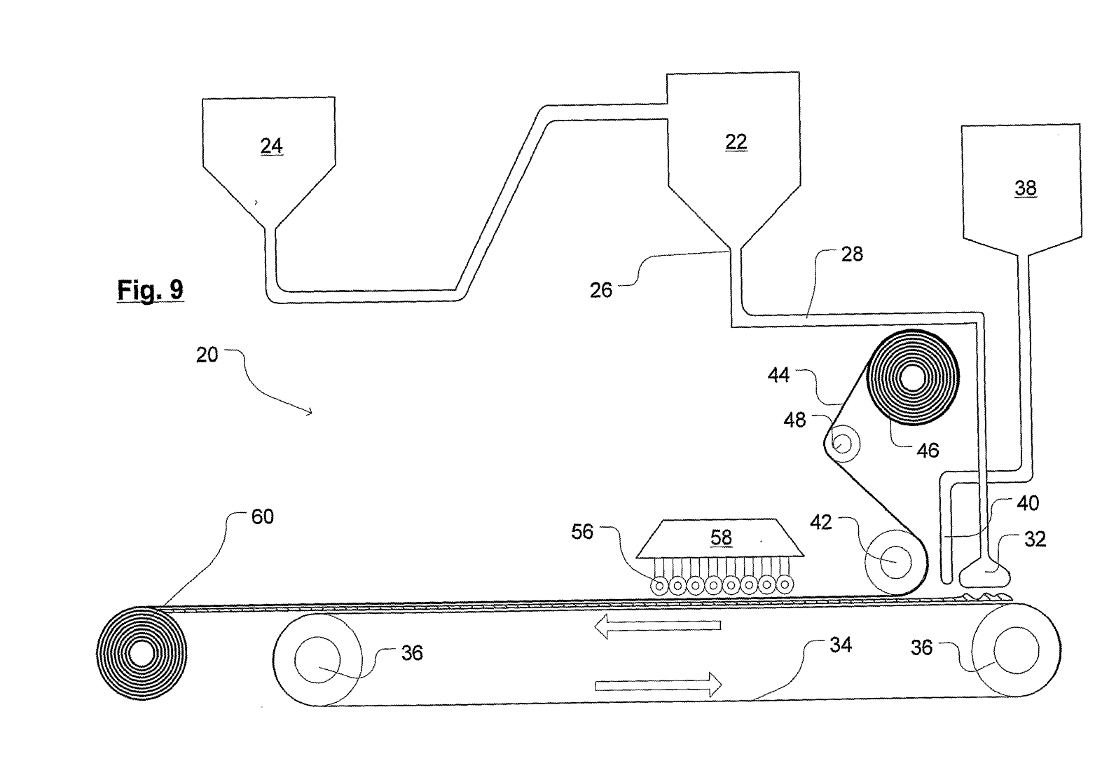

FIG. 9 is a schematic representation of illustrative machinery for producing a mat consisting of a single layer of hair bound to a fusible web.

Referring now to FIG. 1 of the accompanying drawings, the method according to a preferred embodiment of the present invention comprises, in general terms, the steps of: binding (1) a plurality of lengths of cut hair together, manipulating (2) those bound hairs to form a mat, shaping (3) the mat so that it conforms to the shape of the article that is to be manufactured from the composite, applying (4) a structural additive to the shaped mat to form the composite, and curing (5) the composite to yield a generally rigid shaped article. In a particularly preferred envisaged implementation, a core component of the base material comprises cuttings of waste human hair. Such cuttings are typically of random lengths and could most efficaciously be collected from hair salons.

As will be apparent from the following detailed description of preferred embodiments, binding of lengths of hair is intended to encompass any means of assembling lengths of hair into a mass of hair that may then further be manipulated. Assembly of hair lengths may be accomplished by mechanically interlinking or otherwise joining the hair lengths, by adhering lengths of hair together, or by treating the hair lengths so that they naturally tend to interengage with one another.

In one envisaged implementation, the mat is laid up into a mould and then trimmed (for example with a pair of scissors) to confirm to the shape of the mould. The structural additive is then applied to the laid-up mat (for example by painting the additive onto the mat, by filling the mould with additive or by spraying the mat with additive), and the resulting composite is cured to yield a substantially rigid body.

Referring now to FIG. 2 of the accompanying drawings, there is shown a flow diagram illustrating—in more detail—one way of accomplishing steps (1) and (2) of the method depicted in FIG. 1.

The method depicted in FIG. 2 will be described in terms of a manual method for forming hair webs or mats, but it will be appreciated that the principles of any aspect of the following teaching may readily be incorporated into a scaled-up process for manufacturing hair-based base material on a commercial scale.

Referring now to FIG. 2, in a first step of the base material manufacturing method, random lengths of cut human hair are cleaned (6), for example in acetone or an environmentally friendly soap, following which one hand-full of hair is spread evenly on to both beds of two 48 point curved carders (7).

Cleaning of the hair lengths is preferred as it degreases the hair and makes it easier to handle. It should be noted, however, that it is not essential to clean the hair lengths before forming the composition.

Once the carders have been loaded, the hair is then brushed several times in a horizontal direction by interlinking the carders and moving them back and forth relative to one another (8). The hair, following this step of the process, resembles a fluffy ball of hair and is then rolled and pushed to the end of the card. Once the hair is rolled and pliable, it will now be malleable enough to produce a wadding of human hair (9), the wadding consisting of random cut lengths of hair, which can be spun in to a twine (10).

The twine can be of any thickness, and can be spun on a so-called great wheel or other spinning machine as shown in FIG. 10. Once the twine has been created it can be weaved, knitted or crocheted into a mat (11).

FIG. 3 illustrates a modification of the method shown in FIG. 2 (in which similar steps to those of the method of FIG. 2 have been identified with the same reference numerals) illustrating—in more detail—one way of accomplishing steps (1) and (2) of the method depicted in FIG. 1. In this implementation of the method the hair wadding is flattened (12), for example by rolling the wadding, to form a generally planar mat segment.

This mat segment can then be joined to other like segments using a needle punch to form a larger mat, and the larger mat may then be used for “laying up” with a structural additive such as resin, rubber, latex, or cement as described above.

Joining of one segment to another may be accomplished by overlapping the segments that are to be joined and placing the overlapped segments on top of a sponge, following which the overlapped generally flat hair mat segments may be punched with a needle punch to join them together.

FIG. 4 is a schematic representation—in more detail—of another way of accomplishing steps (1) and (2) of the method depicted in FIG. 1.

In this embodiment, once the cut lengths of hair have been cleaned (6), for example by means of acetone or an environmentally friendly soap, they are left to dry. Once dry, the lengths of hair are coupled together (14) by applying a suitable binder (such as a spirit or water based detergent, PVA, wallpaper paste, latex, sugar solution or starch) to the cut hair strands. In one particularly preferred arrangement, the lengths of hair may be bound together by foaming the cut lengths in detergent.

Once the lengths of hair have been bound together, they are left to dry (15) and form a mass of bound lengths of cut hair. This mass of bound hair is then rolled and pressed (16) to form a mat that comprises a substantially flat sheet. As described above, this mat can then be cut into any shape and used to form a composite material (by combination with a suitable structural additive) having the desired shape and configuration.

In an illustrative arrangement, the hair mat or web described above may be laid into a mould by hand, or in another arrangement it could be stippled into a mould. The hair mat could be impregnated with an adhesive before being stippled or otherwise laid into the mould. Although the particular arrangements described above refer to a single ply mat, it will be appreciated that the mat or web may consist of more than one ply, and that the aforementioned “base material” may comprise further components in addition to the mat. For example, in a particularly preferred arrangement the base material may include a fusible web to which the hair mat is attached, the fusible web acting both to bind the hair together and to increase the strength of the base material.

Referring now to FIGS. 5 and 6 of the accompanying drawings, there is depicted a schematic illustrative representation of an apparatus and operating method for the automated manufacture of a base material comprising a multi-layer hair-based matting or webbing that may then be used in the manufacture of a composite as described herein.

The apparatus 20 comprises a hopper 22 into which chopped hair segments are loaded. The hair hopper 22 is coupled to an additive hopper 24 into which additives, such as dyes and/or binding agents are loaded and transferred from the additive hopper 24 to the hair hopper 22. The additives are combined with the hair in the hair hopper 22, and the hair hopper 22 may include stirring blades and motors for rotating those blades so as to assist proper mixing of the hair and additives.

The hair hopper has an outlet 26 which is coupled to a supply pipe that bifurcates into a first branch 28 and a second branch 30, and through which the hair and additive mix is supplied. The first branch 28 includes a hair mix spreader 32 that is configured to vibrate and spread hair transversely (step 17(i), FIG. 5) over an endless conveyor belt 34 mounted for rotation between a pair of rollers 36.

A hopper 38 is loaded with binding solution, for example with a detergent or sugar solution, that when combined with the hair will cause individual hair cuticles to open and loosely bind the hairs together to form a mat. The hopper 38 has an outlet 40 that is configured to supply binding fluid (step 17(ii), FIG. 5) onto the spread hair that has been deposited onto conveyor 34 by the mix spreader 32.

The spread hair mix and binding fluid are transported by the conveyor to a first roller 42 that is configured to draw a fusible web 44 from a roll 46 via a tensioning roller 48 and press the fusible web 44 down onto the spread hair mix and binding fluid to loosely bind the web to the hair mix (steps 17(iii) & 17(iv), FIG. 5). The fusible web may comprise a porous web such as Bondaweb (a registered trademark owned by Carl Freudenberg K G, Höhnerweg 2-4, D-69469 Weinheim, Germany), which web is configured to become tacky when heated.

The mixed hair and overlaid fusible web are transported from the first roller 42 to a second roller 50 that is supplied with hair mix by a hopper 52 that is coupled to the aforementioned second branch 30. The hopper 52 may be configured to vibrate to spread hair transversely over the surface of the web passing below the second roller 50 (step 17(v), FIG. 5). The second roller 50 presses the hair mix from the hopper 52 down onto the fusible web and into the binding fluid carried as part of the mix to loosely bind the hair together and to loosely bind the hair mix to the web so that the web is covered on either side by a layer of hair mix.

The hair mix/web/hair mix “sandwich” 54 then passes to a series of rollers 56 that are configured to press the hair mix layers to the web whilst hot air is blown over the sandwich 54 by a hot air blower 58 above the rollers 56. The hot air blown over the sandwich 54 by the blower 58 is of a temperature that is high enough to melt the fusible web and to close the hair cuticles thereby binding the two layers of hair mix together (step 17(vi), FIG. 5).

The two fused hair layers are drawn from under the rollers 56 and onto a roll 60, which roll comprises a long length of hair mat that can then be used for the manufacture of a composite material as hereinbefore described.

In one illustrative example, the hair mat can be cut into two sections that fit within respective halves of a mannequin mould, following which the mats can be painted or spayed with a suitable bio-degradable polymer resin (the resin acts as the structural additive of the composite). Once the resin has cured the hair mat/resin composites can be removed from the mould and joined one to the other to provide a moulded mannequin that is wholly bio-degradable. In another configuration, the hair mat could be incorporated into a mould that is then filled with resin via an injection moulding process. Many alternative arrangements will be immediately apparent to persons of ordinary skill in the art.

FIG. 7 is a modification of the equipment depicted in FIG. 6 in which common features are designated with common reference numerals. In this arrangement, the application of a fusible web 44 has been omitted, and the two layers of hair are laid one on top of the other before being pressed together and heated. In this arrangement, the heating provided by the heater 58 is likely to be to a lower temperature than in the arrangement shown in FIG. 6 as in this arrangement the heating is only required to dry the mat hair (whereas in FIG. 6 the heating must also melt the fusible web).

FIG. 8 is another modification of the equipment depicted in FIG. 6. In this arrangement, the apparatus is configured to form a mat consisting of a single layer of hair. As with the arrangement depicted in FIG. 7, the heating provided by the heater 58 need only be sufficient to dry the hair mat.

FIG. 9 is another modification of the equipment depicted in FIG. 6, and in this arrangement the apparatus is configured to form a mat consisting of a single layer of hair that has been attached to a fusible web. In this instance the heating provided by the heater 58 is likely to be greater than that provided by the heater 58 of the arrangements shown in FIGS. 7 and 8, the reason being that in this arrangement the heat applied must be sufficient to melt the fusible web as well as dry the hair mat.

It will be apparent from the foregoing, that whilst various preferred embodiments have been herein described, the scope of the present invention is not limited thereto but instead extends to any combination or permutation of features herein described, or indeed to any combination or permutation of equivalents to features herein described.

It should also be noted that the embodiments described herein are provided only by way of example and that modifications may be made with the spirit and scope of the invention.

In another preferred arrangement cut lengths of hair may be cleaned with acetone (or other suitable cleaner such as an environmentally friendly foam), following which they may be added directly to a suitable structural material (for example one part hair may be added to three parts structural material). In this instance the structural material may comprise paint, concrete, clay, a resin or resin mixture, rubber, plastics, or latex. The incorporation of cut lengths of hair into paint has proven to provide a particularly efficacious paint that is more resistant to wear than other previously proposed paint formulations.

1. A method of manufacturing a hair-based composite material, the method comprising: manipulating a plurality of cut lengths of hair to form a web or mat of hair, and combining said web or mat of hair with a structural additive to form said composite material, wherein said manipulating step comprises:
spreading a plurality of cut hair lengths over a surface, applying a binder to said spread hair to form a layer of hair consisting of a plurality of bound cut hair lengths; pressing said layer of bound hair lengths to one side of a web of fusible material; applying a layer of cut hair lengths to the other side of said web of fusible material to sandwich said web between layers of hair; and heating and rolling said sandwich to melt said fusible web and thereby bind said layers of hair together to form said mat or web of hair.

2-7. (canceled)

8. A method of manufacturing a hair-based composite material, the method comprising: manipulating a plurality of cut lengths of hair to form a web or mat of hair, and combining said web or mat of hair with a structural additive to form said composite material, wherein said manipulating step comprises:
spreading a plurality of cut hair lengths over a surface, applying a binder to said spread hair to form a layer of hair consisting of a plurality of bound cut hair lengths; pressing said layer of bound hair lengths to one side of a web of fusible material; and heating and rolling said web and hair layer to melt said fusible web and thereby bind said layers of hair together to form said mat or web of hair.

9. A method according to claim 8, wherein said binder is sugar-based or soap-based.

10. A method according to claim 8, wherein the structural additive comprises one or more of: polymeric material, elastomeric material, resin-based concrete material, starch based material, thermoplastic polymer material, thermoset material, polyamide, epoxy-based resin, or polyester resin.

11. A method according to claim 8, wherein the structural additive is lactic (i.e. derived from milk products), cellulose based, sugar based or otherwise organic or oil based.

12. A method according to claim 8, wherein said hair mat or web comprises a flexible, generally contiguous sheet of hair.

13. A method according to claim 8, wherein said hair comprises human hair.

14. A method according to claim 8, further comprising the step of shaping the mat or web of hair.

15. A method according to claim 8, further comprising the step of laying the mat or web of hair into a mould for a mannequin.

16. (canceled)

17. A method of forming at least part of a mannequin, the method comprising laying a web or mat of hair into a mould of at least part of a mannequin, applying a structural additive to said web or mat, and curing said structural additive.

18. A mannequin formed by the method of claim 17.

19-21. (canceled)

22. A method of manufacturing a web or mat of hair, the method comprising spreading a plurality of cut hair lengths transversely over a conveyor; applying a binder to said spread hair to form a plurality of bound cut hair lengths; pressing said cut hair lengths to one side of a web of fusible material; applying a plurality of cut hair lengths to the other side of said web of fusible material to sandwich said web between layers of hair; and heating and rolling said sandwich to melt said fusibile web and thereby bind said layers of hair together.

23-24. (canceled)

25. A method according to claim 1, wherein said binder is sugar-based or soap-based.

26. A method according to claim 1, wherein the structural additive comprises one or more of: polymeric material, elastomeric material, resin-based concrete material, starch-based material, thermoplastic polymer material, thermoset material, polyamide, epoxy-based resin, or polyester resin.

27. A method according to claim 1, wherein the structural additive is lactic (i.e., derived from milk products), cellulose based, sugar based or otherwise organic or oil based.

28. A method according to claim 1, wherein said hair mat or web comprises a flexible, generally contiguous sheet of hair.

29. A method according to claim 1, wherein said hair comprises human hair.

30. A method according to claim 1, further comprising the step of shaping the mat or web of hair.

31. A method according to claim 1, further comprising the step of laying the mat or web of hair into a mould for a mannequin.
